(19) United States
(12) Patent Application Publication
(10) Pub. No.: US 2016/0162214 A1
(43) Pub. Date: Jun. 9, 2016

(54) ADJUSTABLE LOW SWING MEMORY INTERFACE

(71) Applicants: James A McCall, Portland, OR (US); Christopher P Mozak, Beaverton, OR (US)

(72) Inventors: James A McCall, Portland, OR (US); Christopher P Mozak, Beaverton, OR (US)

(21) Appl. No.: 14/564,055

(22) Filed: Dec. 8, 2014

(51) Int. Cl. G06F 3/06

(52) U.S. Cl. CPC G06F 3/0625; G06F 3/0634; G06F 3/0673

(57) ABSTRACT

A memory device interface with a programmable driver. The memory device is associated with a memory controller, with one or more input/output (I/O) signal lines coupled between the memory device and the memory controller. The memory device includes an I/O signal line interface including a driver for each I/O signal line. The driver is a programmable driver to dynamically adjust an output voltage swing for transmission via the I/O signal line interface.

### FIELD

Embodiments of the invention are generally related to memory subsystems, and more particularly to an adjustable low swing memory interface.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright© 2014, Intel Corporation, All Rights Reserved.

### BACKGROUND

Modern electronic components continue to shrink in size and cost as they find increased usage in mobile and lower power environments. There is an expectation that performance of the electronics will continue to improve even as the size of the components shrinks and as they are expected to have equal or better performance at lower power and similar cost. However, scaling memory performance in terms of bandwidth and lower power while maintaining cost is a continual challenge. Existing memory solutions employ several techniques in the transmission of data to help address scaling bandwidth at a constant or lower overall power budget. One example of an I/O (input/output) scaling technique is evidenced by improved transmit driver architectures. Another technique is the use of unmatched receivers in the transmission of data.

However, traditional constraints on the I/O of typical DRAM (dynamic random access memory) driver stages limit the amount of power reduction that can occur in memory device transmission. Traditional memory device I/O allows adjustments only to the termination of the I/O interface, which has very limited ability to provide power reduction. Traditional memory I/O stages typically have only one or possibly two operational settings. The operating settings of traditional memory I/O have limited adjustability and limited usefulness in power reduction. The one or two settings are traditionally required to span all modes of operation, resulting in power and/or performance inefficiencies. Typically the settings are targeted to the average use case, meaning low-end and high-end configurations tend to be the most inefficient.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system that implements I/O swing control at a memory device.

FIG. 2 is a curve representation illustrating an embodiment of adjustable output voltage swing for a memory device.

FIG. 3 is a block diagram of an embodiment of a system having an I/O interface with reduced I/O transmission swing.

FIGS. 4A-4D are representations of embodiments of an I/O driver with swing control for implementation in a memory device.

FIG. 5 is a block diagram of an embodiment of a system with a variable voltage regulator at a memory device for I/O swing control.

FIG. 6 is a block diagram of an embodiment of a system where a host provides an I/O voltage source to provide swing control at a memory device.

FIG. 7 is a block diagram of an embodiment of a system with an external regulator to provide an I/O voltage source to provide swing control at a memory device.

FIG. 8 is a flow diagram of an embodiment of a process for controlling I/O swing internally at a memory device.

FIG. 9 is a flow diagram of an embodiment of a process for controlling I/O swing of a memory device externally.

FIG. 10 is a block diagram of an embodiment of a computing system in which memory device I/O swing control can be implemented.

FIG. 11 is a block diagram of an embodiment of a mobile device in which memory device I/O swing control can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a memory device I/O (input/output) interface includes a programmable driver. The programmable driver enables the memory device to control the output voltage swing for the I/O interface. The I/O interface includes multiple signal lines, coupled between the memory device and an associated memory controller. The memory device I/O interface includes a driver for each I/O signal line. The driver is a programmable driver to dynamically adjust the output voltage swing for transmission via the I/O interface.

In one embodiment, the memory device I/O interface includes a transmit driver controlled by the associated memory controller. Thus, the memory controller can control the output voltage swing of a transmit driver of the memory device. The memory controller can set or program the output voltage swing dynamically to enable the memory device to transmit an output signal with a variable output voltage swing. The variable output voltage swing, in some conditions the memory device can transmit at a lower power than a traditional I/O interface. Such dynamic output voltage swing control can provide scaling for bandwidth of the memory I/O interface while providing power and performance optimizations. In one embodiment, the transmit driver is a voltage mode driver. A voltage mode driver outputs a voltage signal, and typically matches its effective impedance to the signal line. A voltage mode driver is understood to be different from a current mode driver that outputs a current. In one embodiment, the transmit driver is single-ended, which references a signal line signal to a low-voltage rail. A differential driver operates on a signal line pair, where the signal is the difference between the two signal lines.

It will be understood that reference to dynamic output voltage swing control refers to control over the voltage levels used to generate an output signal, in contrast to traditional methods of controlling output voltage swing related to adjusting I/O driver resistance. The output voltage swing control described herein can be accomplished in addition to adjusting I/O driver resistance, but does not rely solely on adjusting I/O driver resistance to adjust the output voltage swing for the I/O. It will be understood that adjusting I/O driver resistance can reduce the efficiency of matching the driver to the channel's transmission line impedance. Thus, there is traditionally a conflict between achieving low power and good signaling (i.e., adjusting the driver resistance to lower power consumption traditionally results in poorer signaling). By adjusting I/O output voltage swing independently of I/O driver resistance, the adjustment to the output voltage swing described herein can lower power consumption with minimal to no impact on signaling quality.

In one embodiment, the dynamic I/O interface control can be provided via on-die regulation on the memory device, with the on-die regulation controlled by the memory controller. In one embodiment, the dynamic I/O interface control can be provided via sourcing a transmit output stage from the memory controller to the memory device. Such an embodiment enables the memory controller to directly control the voltage swing control at the memory controller and source it to the memory device.

For example, the dynamic output voltage swing control can enable power reduction for data transmission at higher frequencies, which can offset the potential power to scale the clock rate. In one embodiment, a system using dynamic output voltage swing control for the memory device can allow independent output voltage swing (Vswing) and on-die termination (Ron) control, which will yield improved power and performance optimization in comparison to the existing memory I/O interfaces.

In traditional I/O interface controls on memory device I/O interfaces, the memory I/O interface has one or two settings for multiple settings cases, which provides limited adjustability. Instead of one or two settings that are required to span all modes of operation for a memory I/O interface, the dynamic output voltage control allows more setting cases, which allows greater variability across different modes of operation of the memory I/O interface. Thus, a single I/O interface design can be dynamically modified to different settings to allow adjusted use cases for multiple different segments of transmission transactions. The dynamic output voltage control memory I/O interface allows more extensive power and performance optimization by allowing adjustments to both termination settings and output voltage swing.

As mentioned above, the dynamic output voltage swing can be controlled by the memory controller, and implemented at the memory device or the memory controller. In one embodiment, the memory device includes a programmable or adjustable voltage regulator on die or on circuit. Thus, the memory device itself can receive a source voltage and generate different output voltage levels to produce different output voltage swings. In one embodiment, the memory controller generates a regulated voltage that it provides to the memory controller to use as a voltage rail for transmitting an output signal. Thus, controlling the regulated voltage at the memory controller can control the voltage swing at the memory device. In one embodiment, a voltage regulator external to the memory controller and the memory device generates and delivers a regulated voltage to the memory controller for use by the memory controller in an output stage for transmission of a signal. In one embodiment, the memory controller controls the output voltage swing of the memory device via a command to the memory device. In one embodiment, the memory controller controls the output voltage swing of the memory device via setting a mode register. The driver of the memory device is programmable in that it operates on a controllable voltage.

In one embodiment, output voltage swing level can be optimized for each different system. For example, output voltage control can be configurable by firmware. By adjusting configuration settings within the firmware, the firmware can adjust the output swing differently for each system in which the output voltage control is incorporated. In one embodiment, the output voltage control can adjust its control in response to directly configured variables. In one embodiment, the output voltage control can adjust its control in response to configuration settings or other variables in BIOS (basic input/output system) or other system configuration storage. In one embodiment, output voltage control adjusts the operation of one or more voltage regulators to control the I/O swing. In one embodiment, the output voltage control can additionally adjust performance of a voltage regulator to improve efficiency and/or reduce supply noise. For example, the output voltage control can adjust filter settings, quiescent current, non-linear controls, low-load power management, or other regulator performance parameters, or a combination of parameters.

Reference to memory devices can apply to different memory types. Memory devices generally refer to volatile memory technologies. Volatile memory is memory whose state (and therefore the data stored on it) is indeterminate if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), WIO3 (Wide I/O 3, currently in discussion by JEDEC), HBM2 (HBM version 2), currently in discussion by JEDEC), and/or others, and technologies based on derivatives or extensions of such specifications. In addition to, or alternatively to, volatile memory, in one embodiment, reference to memory devices can refer to a nonvolatile memory device whose state is determinate even if power is interrupted to the device. Thus, a memory device can also include a future generation nonvolatile devices, such as a three dimensional crosspoint memory device, or other nonvolatile memory device.

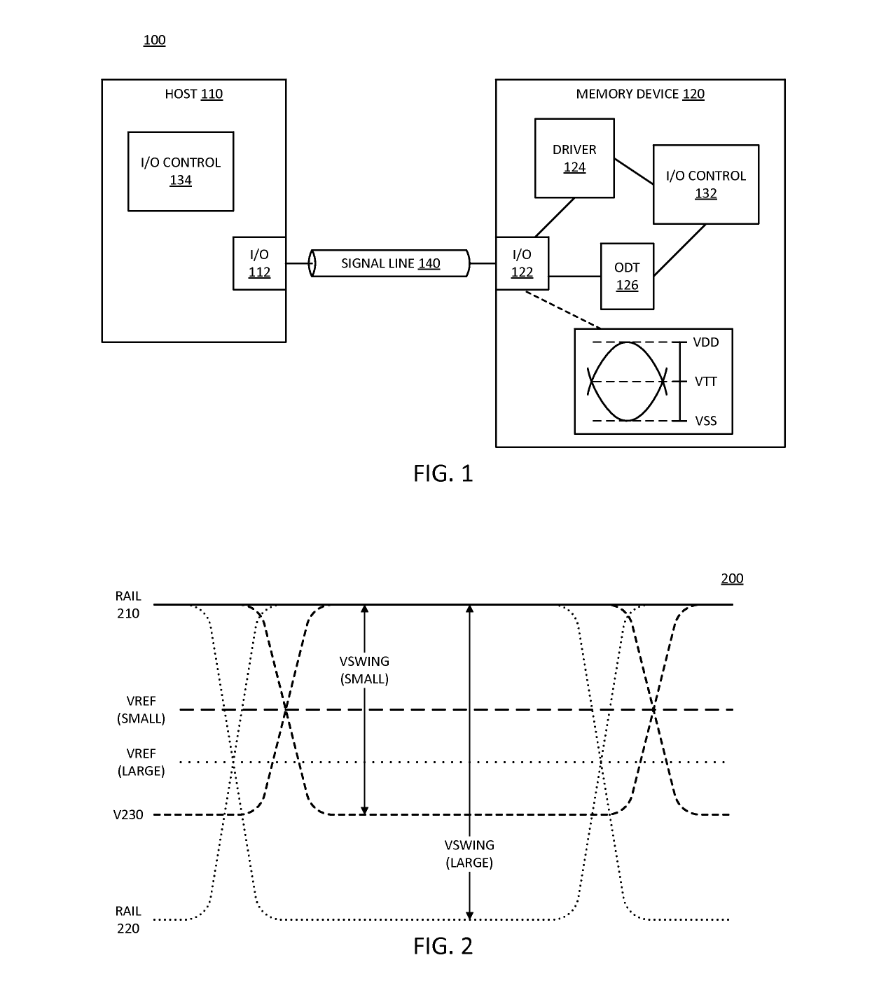

FIG. 1 is a block diagram of an embodiment of a system that implements I/O swing control at a memory device. System 100 represents a system that includes a memory device. In one embodiment, system 100 can be considered to be a memory subsystem. Host 110 represents a host system that implements control in a computing device. In one embodiment, host 110 includes a processor or processing unit, which can include one or more processor devices and/or processor cores. Host 110 includes a memory controller or logical equivalent or substitute for a memory controller. The memory controller controls memory access to memory device 120.

Host 110 can be coupled to one or more memory devices 120. Multiple memory devices can be coupled in parallel to host 110. The I/O interface between host 110 and memory device 120 can be separated into one or more channels, banks, ranks, buses, or other groupings. Typically, a grouping of signal lines of an interface can be understood as sharing signaling, such as sharing a clock signal or other control signal. In an embodiment where the interface between host 110 and memory device 120 is separated into groups of signal lines, certain signal lines groups could be active while others are not selected. Such signal lines can still be connected, but commands can signal which device or signal lines should receive and operate on the command, and which should dismiss the command.

Memory device 120 represents memory resources in system 100. Memory device 120 includes a storage array or other storage architecture, which is not explicitly shown. Memory device 120 stores data in the storage array. In one embodiment, memory device 120 is a volatile memory device, which refers to a memory whose state is indeterminate when power is interrupted to the device. In one embodiment, memory device 120 can be a nonvolatile memory device, which refers to a memory whose state is determinate even if power is interrupted to the device. In one embodiment, memory device 120 can be a three dimensional (3D) crosspoint nonvolatile memory device. In one embodiment, memory device 120 represents a main memory resource for host 110 to store data and/or code to execute.

Memory device 120 includes I/O 122, which interfaces with I/O 112 of host 110 via signal line 140. I/O 122 and I/O 112 represent hardware logic that interconnects or couples the respective device to an external device. While only shown as a single block with a single signal line 140, it will be understood that host 110 and memory device 120 include multiple I/O ports, pins, or connectors. Thus, I/O 112 and I/O 122 can represent an I/O interface of any size between host 110 and memory device 120. I/O 122 of memory device 120 is controlled by one or more connections to the I/O. Memory device 120 includes a representation of an idealized signal eye for communication via I/O 122.

The signal eye represents rail-to-rail voltage swings for communication via I/O 122. The rails refer to the high voltage rail or high voltage potential, which can be referred to as VDD, and a low voltage rail or low voltage potential, which can be referred to as VSS. For reference, the signal eye also represents a third voltage potential labeled VTT, referring to a voltage rail somewhere between VDD and VSS. In one embodiment, VTT is a midrail between VDD and VSS. In one embodiment, VTT is a common mode or average voltage of the I/O lines. VTT can be a voltage where the pull-up and pull-down currents are equal. In one embodiment, VTT can be at a voltage potential that is not directly between VDD and VSS. In one embodiment, either or both of VSS and VDD are dynamically adjustable, and VTT may be fixed relative to a source voltage instead of VSS and/or VDD; thus, VTT can be a voltage other than midway between VSS and VDD due to dynamic movement of one or the other of the extreme voltage rails.

Traditionally, memory device 120 includes ODT (on-die termination) 126 to terminate one or more signal lines or one or more devices while communication occurs with other signal lines and/or other devices. ODT 126 can terminate signal line 140 to VDD, VSS, or VTT. In one embodiment, ODT 126 includes multiple different settings or modes to terminate different signal lines to different levels under different modes of operation. In one embodiment, host 110 controls the termination to be applied by ODT 126 at memory device 120.

Memory device 120 includes driver 124, which represents a circuit to drive I/O 122 to a logic high or a logic low, depending on which bit is to be represented over signal line 140. It will be understood that driver 124 is part of I/O 122. Driver 124 is part of the circuitry that outputs a signal over signal line 140. Thus, expressions herein referring to driver 124 driving I/O 122 refers to the driver driving the output signal lines to send communication to the host or associated memory controller. In one embodiment, driver 124 is programmable. In one embodiment, drive strength and/or voltage swing is controlled and adjustable. Drive strength can refer to resistance looking into the driver's output. Voltage swing refers to how completely an output signal swings between VDD and VSS. For example, programmable driver 124 can be configured to drive the signal line to some voltage value less than VDD to represent a logic high, instead of driving the signal line all the way to VDD to represent the logic high.

In one embodiment, driver 124 is a single-ended driver, and outputs a signal relative to a low-voltage rail. In one embodiment, driver 124 is a voltage mode driver. A voltage mode driver is modeled as a voltage source, and outputs a voltage signal. The voltage mode driver impedance matches based on an equivalent impedance looking back into the circuit from the connected signal line. A current mode driver is modeled as a current source, and outputs a current signal.

In one embodiment, memory device 120 includes I/O control 132, which represents logic to control the configuration and operation of I/O 122. In one embodiment, I/O control 132 includes hardware logic. In one embodiment, I/O control 132 includes software logic. In one embodiment, I/O control 132 includes a combination of hardware and software logic. The hardware logic can include, for example, an on-die controller or processor device that controls the timing and signaling operations of the hardware logic of driver 124, ODT 126, and I/O 122. In one embodiment, such a controller can include programmed logic (such as firmware code) to make determinations on how to operate.

In one embodiment, host 110 includes I/O control 134, which represents logic to control the configuration and operation of I/O 122 of memory device 120. In one embodiment, I/O control 134 is separate from logic that controls the operation of I/O 112 of host 110. In one embodiment, I/O control 134 includes hardware logic. In one embodiment, I/O control 134 includes software logic. In one embodiment, I/O control 134 includes a combination of hardware and software logic. The hardware logic can include, for example, an on-die controller or processor device that generates commands to control the timing and signaling operations of the hardware logic of driver 124, ODT 126, and I/O 122. In one embodiment, such a controller can include programmed logic (such as firmware code) to make determinations on how to operate. I/O control 134 can cause communication between host 110 and memory device 120, which may be over the interface of I/O 112, signal line 140, and I/O 122, or over another interface (not shown).

In one embodiment, driver 124 is self-controlled at memory device 120. In such an embodiment, I/O control 132 handles the control of driver 124 internally. Thus, I/O control 132 controls dynamic voltage swing of I/O 122 by adjusting the operation of driver 124. In one embodiment, I/O control includes a variable voltage regulator to generate a reduced-swing reference voltage for driver 124. In one embodiment, driver 124 can be considered to include a variable voltage regulator controlled by I/O control 132.

In one embodiment, host 110 at least partially controls the variable operation of driver 124. In such an embodiment, I/O control 134 can directly control driver 124, or can signal I/O control 132 to configure the driver for a particular mode of operation. In one embodiment, I/O control 132 includes a mode register or other register or reference table that controls the operation of the driver 124. In one embodiment, I/O control 134 generates a voltage reference rail for driver 124 to transmit a signal over I/O 122, which can include a reduced voltage swing.

It will be understood that host 110 can include one or more memory controllers or comparable circuits. Each memory controller can be associated with one or more memory resources. Each memory controller will control its associated memory resources independently of other memory controllers. In an embodiment where host 110 is considered to have or be a memory controller, I/O control 134 can be part of the memory controller associated with memory device 120. The associated memory controller controls access to storage resources of memory device 120.

In one embodiment, when host 110 or a memory controller controls the programmable swing of driver 124, the granularity of control over the variability of the voltage swing is likely to be at the channel, rank, or device level. In one embodiment, finer level granularity of control can be managed by host 110 or a memory controller, but such an implementation might include an unworkable amount of hardware and/or software logic to implement. Thus, in one embodiment, finer level granularity of control, such as byte, bit, or bus level is provided at least in part by internal control via I/O control 132. It will be understood that I/O control 134 can signal operations for memory device 120 which will be carried out by I/O control 132.

In one embodiment, memory device 120 has multiple different operating modes. The operating modes can be designated for power saving, for performance, for certain data types, or some other designation for a mode. In one embodiment, different operating modes apply different I/O frequency from memory device 120. In one embodiment, memory device 120 configures I/O 122 differently for the different operating modes (e.g., adjusting frequency, output power, and/or other parameters). Thus, in one embodiment, I/O control 132 can control the configuration of I/O 122 and/or driver 124 based on the operating mode the memory device. In one embodiment, the operating mode of the memory device is set by a mode register (not specifically shown) at memory device 120, which stores configuration and operating information for the memory device. Thus, in one embodiment, programmable driver 124 dynamically adjusts output voltage swing based on the operating mode as set in a mode register. In one embodiment, host 110 or a memory controller sets an operating mode via a command or command sequence. Thus, in one embodiment, programmable driver 124 dynamically adjusts output voltage swing based on the operating mode as set via a command received by the memory device from the memory controller.

FIG. 2 is a curve representation illustrating an embodiment of adjustable output voltage swing for a memory device. Diagram 200 illustrates standard and reduced voltage swings for a memory device output driver in accordance with any embodiment described herein. Diagram 200 illustrates voltage rails 210 and 220, which can represent high and low voltage rails for an adjustable output driver in a memory device.

Vswing_large represents a traditional implementation of an output from a driver, where the voltage swings from rail 210 to rail 220. In one embodiment, the memory device output driver can be configured to swing between rail 210 and V230 instead of rail 210 and rail 220. Vswing_small represents a reduced swing output from the memory device driver. In one embodiment, the memory device generates the voltage levels represented by rail 210 and V230. In one embodiment, one or both voltage levels are sourced by an associated memory controller.

When the output driver swings from rail 210 to rail 220, there can be a reference voltage for the Vswing_large, which is shown approximately halfway between rail 210 and rail 220. When the output driver swings from rail 210 to V230, there can be a reference voltage for the Vswing_small, which is shown approximately halfway between rail 210 and V230. It will be understood that while V230 is shown relative to rail 210, the voltage could swing between rail 220 and another voltage. It will be understood that rail 210 could be a high voltage rail or a low voltage rail. In one embodiment, the adjustable memory device output driver can be programmed with more voltage swing choices than the two illustrated. Thus, the adjustment of the output voltage swing can be more granular to allow for more than two different voltage swings.

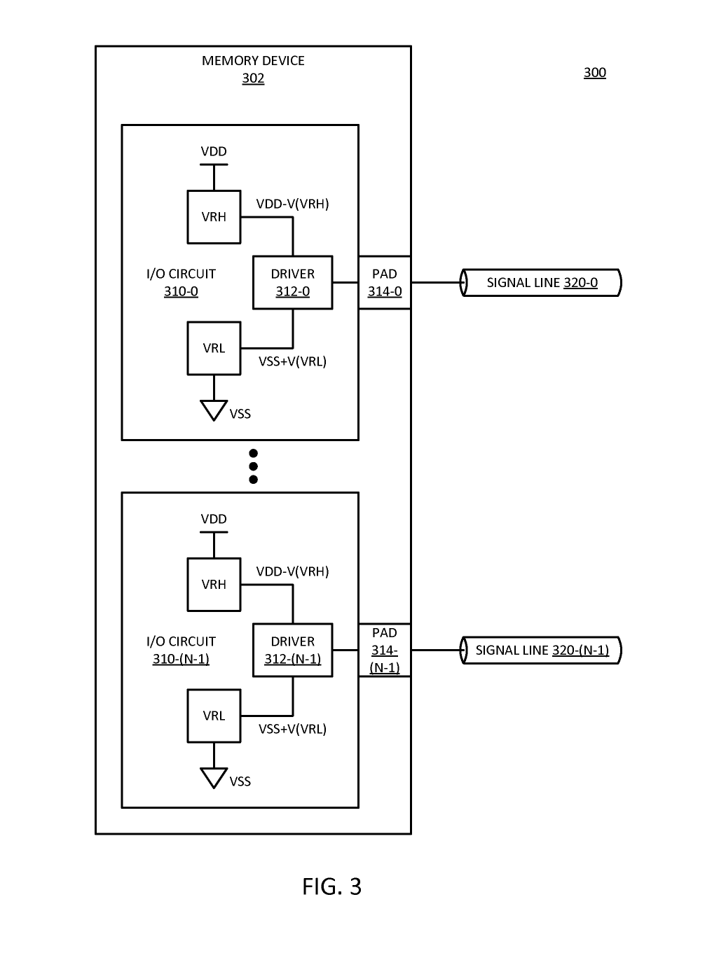

FIG. 3 is a block diagram of an embodiment of a system having an I/O interface with reduced I/O transmission swing. System 300 represents an I/O interface at the side of a memory device. Specifically, memory device 302 includes N pads 314 coupled to N signal lines 320. Pads 314 represent the hardware interconnection of signal lines 320 with memory device 302. Pads 314 are the hardware through which memory device 302 interfaces with the communication interface of signal lines 320.

In one embodiment, each pad 314 includes an associated I/O circuit 310. I/O circuits 310 are a simplified representation of a driver circuit for generating an output on signal lines 320. It will be understood that I/O circuits 310 can each be controlled separately to generate different bits on each signal line 320. The structure of each I/O circuit 310 can be basically the same; thus, only I/O circuit 310-0 will be described, and it will be understood that such descriptions can apply equally well to all I/O circuits and their constituent elements.

Driver 312 represents a programmable driver in accordance with any embodiment described herein. In one embodiment, driver 312 represents a final output stage of a driver for pad 314. Driver 312 can operate to pull the associated pad and signal line to one of two voltage rails. Nominally the voltage rails can be VDD for the high voltage and VSS for the low voltage. In one embodiment, I/O circuit 310 includes either a high voltage regulator (VRH), or a low voltage regulator (VRL), or both. VRH represents a voltage regulator that generates a voltage that is lower than VDD, of a value equal to VDD-V(VRH), or the system high voltage rail (VDD) minus the voltage drop of VRH. Similarly, VRL represents a voltage regulator that generates a voltage that is higher than VSS, of a value equal to VSS-V(VRL), or the system low voltage rail (VSS) plus the voltage of VRL. It will be understood that the magnitude of the step-down provided by VRH is not necessarily the same as the magnitude of the step-up provided by VRL, even in an embodiment where both VRH and VRL are present.

The reduction in output voltage swing can provide power savings for I/O circuit 310 as compared to a design that swings from rail to rail. Assume that VRH is included in I/O circuit 310, providing an output voltage of VDD-V(VRH). If VRH is a linear voltage regulator, the design of system 300 will reduce transmit power in a linear relationship to the voltage reduction provided by VRH. If VRH is designed as a switching voltage regulator or switched circuit regulator (e.g., a switched capacitor regulator, switched inductor regulator), the design of system 300 can reduce transmit power in nearly a quadratic relationship to the voltage reduction provided by VRH.

In one embodiment, VRH can be integrated locally on the same semiconductor die or integrated circuit as I/O circuit 310, with very low area overhead. For example, a device design often has enough whitespace to accommodate implementation of a voltage regulator in I/O circuit 310. In one embodiment, VRH is integrated in the same package or on the same board as I/O circuit 310 without necessarily being integrated in the same semiconductor substrate. Similarly, VRL could be integrated on the same semiconductor substrate as I/O circuit 310, or in the same package as I/O circuit 310.

In one embodiment (not explicitly shown), one or both voltage regulators VRH and VRL can be selectively bypassed via a bypass path. The bypass path can be selectively activated to switch connecting to a voltage rail through the voltage regulator or connecting to the voltage rail directly. Thus, for example, the input to the regulator and the output of the regulator can be coupled through a selective (e.g., switched) low impedance path that will bypass the regulator when activated. Such a design could be used to interface with different types of systems (e.g., offering a full swing mode and a separate low swing mode). Additionally, the voltage regulator could be switched off when not needed, such as for receiving a signal instead of driving transmission of a signal. Thus, in low power states, the voltage regulator can double as a power gate and shut off power to the driver when not in use, which can reduce circuit leakage.

It will be understood that with a separate I/O circuit 310 for each separate signal line 320, memory device 302 can provide many levels of granularity in the programmability of the output swing. In one embodiment, each bit can be programmed or configured separately for voltage swing, providing bit level control over output swing. In one embodiment, each I/O circuit 310 is separate, but controlled in parallel or in groups of parallel bits, which can provide byte-level or device-level granularity, or some other granularity, for output swing control. Each bit or other grouping could use different output voltage swings, depending on the configuration of system 300. In one embodiment, each bus can be programmed or configured separately for voltage swing, providing bus-level control over output swing. For example, data bus and command/address bus can be controlled separately. In one embodiment, a memory subsystem is separated into different ranks, and each rank can be programmed or configured separately for voltage swing, providing rank-level control over output swing.

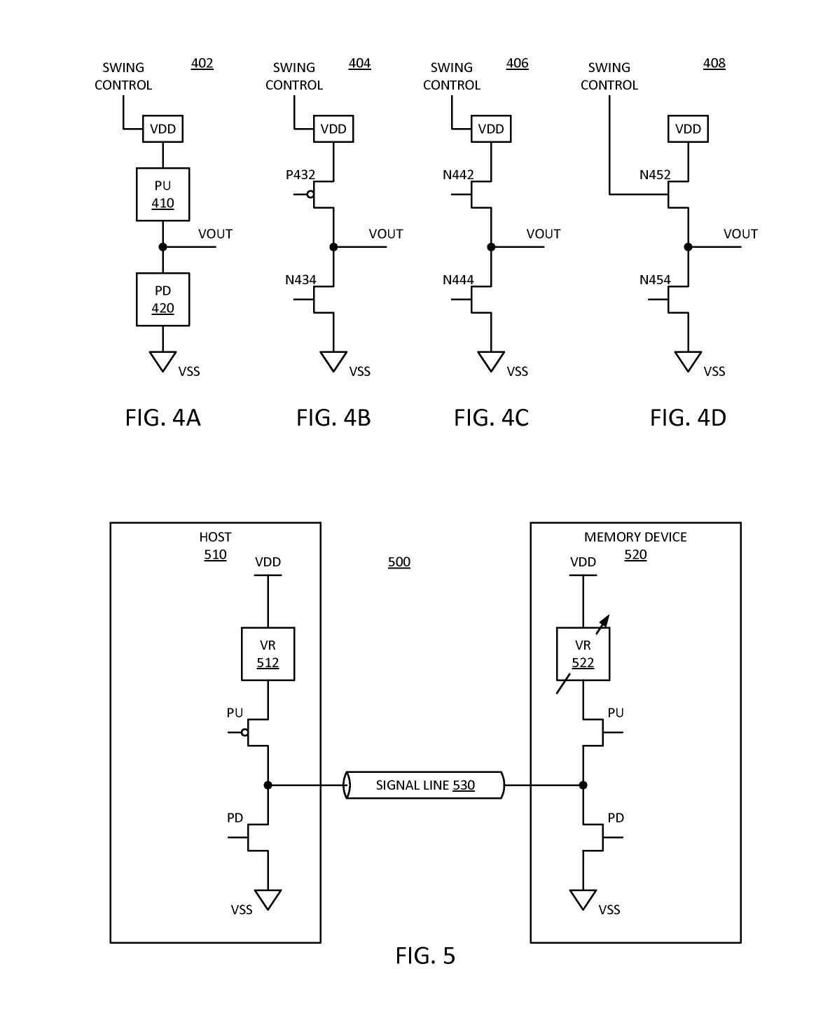

FIGS. 4A-4D are representations of embodiments of an I/O driver with swing control for implementation in a memory device. Referring to FIG. 4A, circuit 402 represents a driver architecture with pull-up (PU) 410 to pull Vout towards VDD, and pull-down (PD) 420 to pull Vout towards VSS. Circuit 402 can represent a driver in accordance with any embodiment of a driver herein. In one embodiment, circuit 402 is a CMOS circuit, where pull-up 410 can be implemented with one or more transistors, and pull-down 420 can likewise be implemented with one or more transistors. In one embodiment, circuit 402 is configurable by swing control that controls the voltage level of VDD. By adjusting VDD down, the output swing at Vout can be reduced. By adjusting VDD up, the output swing at Vout can be increased. In one embodiment, there can be separate swing control of VSS.

Typically, either pull-up 410 or pull-down 420 will be active at a time, but not both at the same time. There may be some overlap where both devices are active during a transition, but in general, circuit 402 will typically operate to have one leg active while the other is inactive. Thus, the active leg will conduct current and equalize the voltage potential between the rail coupled to the leg (VDD for pull-up 410, and VSS for pull-down 420) and Vout.

Referring to FIG. 4B, circuit 404 represents a driver architecture with a p-type pull-up P432 to pull Vout towards VDD, and an n-type pull-down N434 to pull Vout towards VSS. Circuit 404 can be referred to as an n-type-p-type driver or a p-type-n-type driver, given that one of the legs is n-type and the other is p-type. In a CMOS implementation, circuit 402 can be referred to as an NMOS-PMOS or PMOS-NMOS driver. It will be understood that a p-type material is a doped semiconductor that is doped to increase hole mobility, freeing holes to conduct current. An n-type material is a doped semiconductor that is doped to increase electron mobility, freeing electrons to conduct current. When the respective transistor device is biased at least to a threshold (Vt), the device conducts current. In one embodiment, swing control for circuit 404 can provide control over VDD, and thus over a voltage swing for Vout.

Referring to FIG. 4C, circuit 406 represents a driver architecture with an n-type pull-up N442 to pull Vout towards VDD, and an n-type pull-down N444 to pull Vout towards VSS. Circuit 406 can be referred to as an n-type-n-type driver, given that both legs are n-type. In a CMOS implementation, circuit 406 can be referred to as an NMOS-NMOS driver. It could also be possible to create a p-type-p-type driver, but such an architecture is not typically practical in current circuit designs. In one embodiment, swing control for circuit 406 can provide control over VDD, and thus over a voltage swing for Vout. Referring to FIG. 4D, circuit 408 represents a driver architecture with an n-type pull-up N452 to pull Vout towards VDD, and an n-type pull-down N454 to pull Vout towards VSS. In one embodiment, swing control for circuit 408 can provide control to the gate of N452, and thus control a voltage swing for Vout. Alternatively or additionally, swing control could be provided at the gate of N454.

Any architecture described (e.g., n-type-n-type, n-type-p-type, p-type-p-type, or p-type-n-type) can be used for any driver of an interface between a memory controller and a memory device. Any of the driver architectures could be combined with any form of termination (e.g., VDD, VSS, or VTT termination). Thus, output swing control is independent of termination type and resistance of the driver.

FIG. 5 is a block diagram of an embodiment of a system with a variable voltage regulator at a memory device for I/O swing control. System 500 includes host 510, which represents a memory controller or other host circuit that couples to memory device 520. System 500 can be one example of a system in accordance with system 100 of FIG. 1. System 500 represents an embodiment in which a programmable driver of memory device 520 internally generates or programs the output voltage swing. Host 510 programs the swing, which is controlled internally within memory device 520.

In one embodiment, host 510 includes VR (voltage regulator) 512 to control its driver circuit, which can include a PMOS pull-up and an NMOS pull-down. It will be understood that the driver can have a different architecture than what is shown. VR 512 can set the voltage used for output swing control by host 510 to drive signal line 530. Memory controllers or other host devices have traditionally included output voltage swing control. System 500 includes swing control for memory device 520. Specifically, memory device 520 includes an output driver with variable voltage regulator 522. Memory device 520 can have a driver circuit with an NMOS pull-up and an NMOS pull-down, or some other driver architecture. VR 522 can control the output voltage swing of the driver.

In one embodiment, output voltage swing control provided by VR 512 and/or VR 522 can be in addition to one or more other forms of output driver control. In one embodiment, system 500 can control resistance, duty cycle, edge rate, and/or equalization control, and/or other characteristics or operational parameters of the output driver of memory device 520. In one embodiment, the control that generates the adjustments to output voltage swing control of the output driver can alternatively, or additionally, adjust one or more voltage regulator characteristics or operational parameters, including regulator bandwidth, regulator efficiency, non-linear control, or low-load power management. Thus, a programmable driver as described herein can be said to control the output voltage swing in addition to one or more characteristics of the voltage regulator that controls the output voltage swing (e.g., VR 522).

In one embodiment, VR 522 is responsive to control or command signals from host 510, which can configure the operation of the memory device driver to have larger or smaller output swing. Despite being responsive to control by host 510, it will be understood that VR 522 and the driver are controlled internally. Thus, host 510 can simply signal to memory device 520 to use a particular power saving mode, or more specifically to reduce transmission power. In response to such a command (or more explicit commands), a controller (not specifically shown) in memory device 520 can generate control signals for VR 522 and adjust the output swing of the output driver. In one embodiment, the memory device driver supports multiple swing levels, such as a low, medium, and large voltage swing. Other implementations are possible, and any reasonable number of swing levels can be applied at memory device 520.

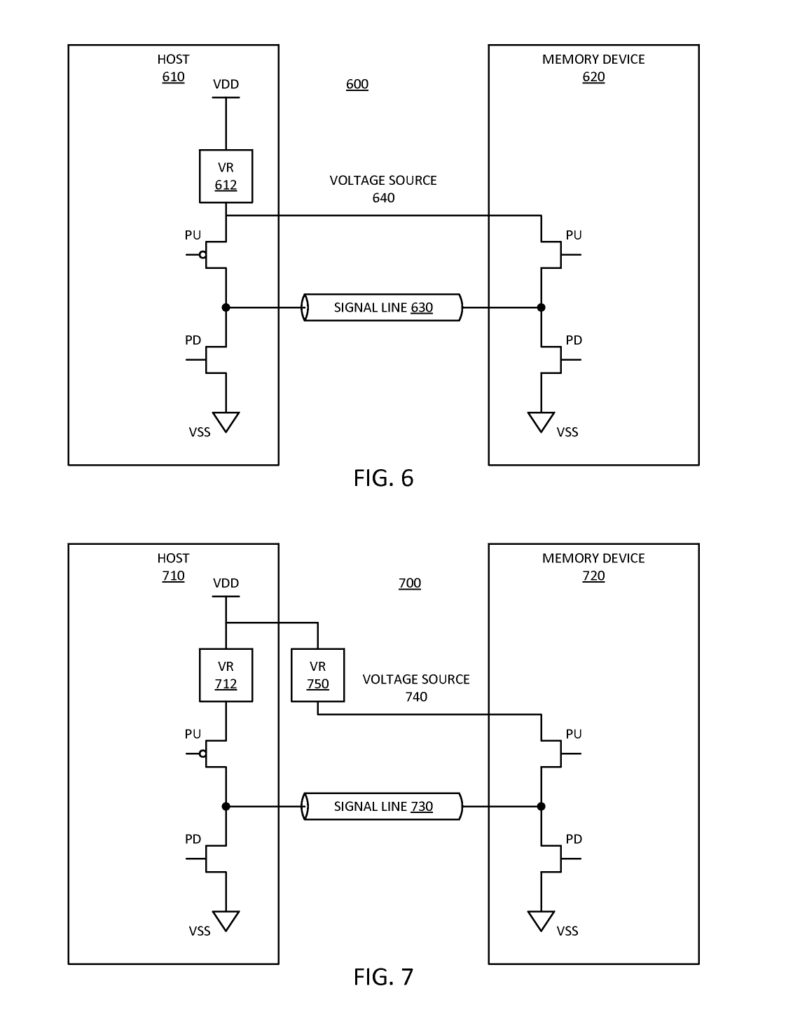

FIG. 6 is a block diagram of an embodiment of a system where a host provides an I/O voltage source to provide swing control at a memory device. System 600 includes host 610, which represents a memory controller or other host circuit that couples to memory device 620 over signal line 630. System 600 can be one example of a system in accordance with system 100 of FIG. 1, and an alternative to system 500 of FIG. 5. System 600 represents an embodiment in which a programmable driver of memory device 620 is programmable via output swing control generated by host 610. More specifically, host 610 sources a voltage to memory device 620 for use by the memory device output driver. Thus, host 610 can optimize the output voltage swing of memory device 620 via control of VR 612.

Similar to what is described above with reference to system 500, host 610 can include a PMOS pull-up and an NMOS pull-down driver architecture while memory device 620 can include an NMOS pull-up and an NMOS pull-down driver architecture. It will be understood that these architectures are merely illustrative, and other architectures could be used. Voltage source 640 represents the voltage sourced from host 610 to memory device 620 for the output driver. In one embodiment, voltage source 640 can be a voltage level generates by host 610 specifically for the output driver of memory device 620. In one embodiment, voltage source 640 is the same voltage generated by host 610 for its own output driver. Thus, the programmable output voltage swing of memory device 620 can track a variable output voltage level used by an associated memory controller. While voltage source 640 is shown as a high voltage rail used by the memory device driver, it will be understood that host 610 can generate a low voltage rail for the memory device driver in addition to or in place of a high voltage rail.

FIG. 7 is a block diagram of an embodiment of a system with an external regulator to provide an I/O voltage source to provide swing control at a memory device. System 700 includes host 710, which represents a memory controller or other host circuit that couples to memory device 720 over signal line 730. System 700 can be one example of a system in accordance with system 100 of FIG. 1, and an alternative to system 500 of FIG. 5 or system 600 of FIG. 6. System 700 represents an embodiment in which a programmable driver of memory device 720 is programmable via output swing control generated by a voltage regulator separate from both the memory device and an associated memory controller. In one embodiment, voltage regulator 750 is a regulator that is already present and used in system 700, which can be reused to control output voltage swing for memory device 720. In one embodiment, voltage regulator 750 controls output voltage swing for memory device 720, and can be reused by one or more other portions of system 700 (e.g., other portions not specifically shown).

In one embodiment, voltage regulator 750 sources an output voltage level to both the driver of host 710 and the driver of memory device 720. With respect to memory device 720, voltage regulator 750 can provide voltage source 740 to the memory device driver. In one embodiment, host 710 still includes voltage regulator 712 to regulate a voltage provided by voltage regulator 750. In one embodiment, the use of voltage regulator 750 can be considered to have host 710 source the output voltage of the memory device driver indirectly, as opposed to directly sourcing the voltage level from an internal voltage regulator. In either the directly source case (such as system 600) or the indirectly sourced case, having host 710 source the voltage to the memory device output driver can enable independent output swings, which allows much lower read swings due to better receive characteristics on the host side. In one embodiment, voltage source 740 is the same voltage level applied to the output driver of host 710. In one embodiment, voltage source 740 is different from the voltage applied to the output driver of host 710.

Similar to what is described above, host 710 can include a PMOS pull-up and an NMOS pull-down driver architecture while memory device 720 can include an NMOS pull-up and an NMOS pull-down driver architecture. It will be understood that these architectures are merely illustrative, and other architectures could be used. Also, voltage source 740 is shown as a high voltage rail used by the memory device driver, but it will be understood that host 710 can generate a low voltage rail for the memory device driver in addition to or in place of a high voltage rail.

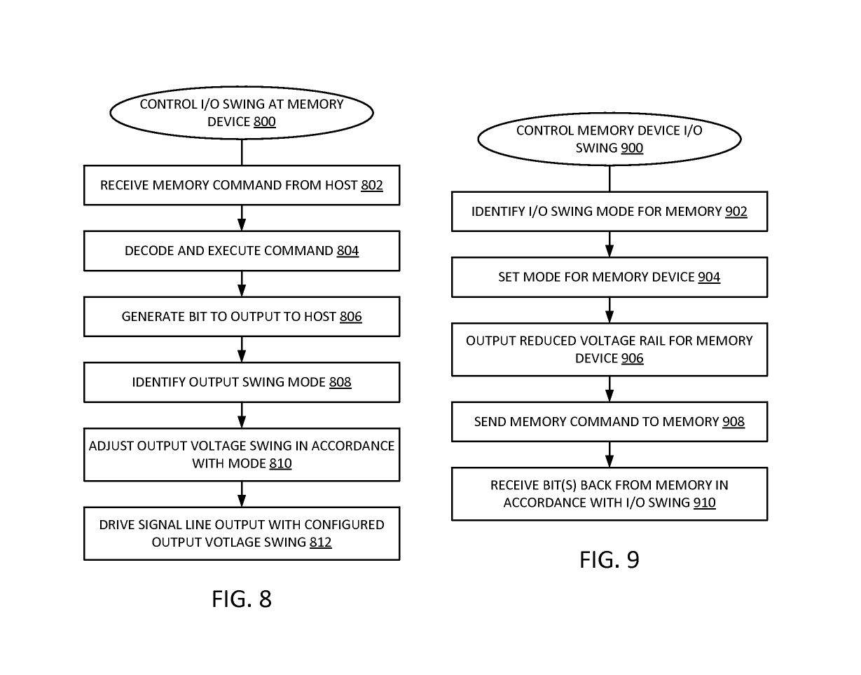

FIG. 8 is a flow diagram of an embodiment of a process for controlling I/O swing internally at a memory device. In one embodiment, a memory device internally generates programmable voltage levels to control the output voltage swing of an output driver of the memory device. The memory device can generate the voltage levels in response to control signals from an associated memory controller. The memory device can control the I/O swing in accordance with flow 800, and in accordance with any embodiment described herein. In one embodiment, the memory device receives a memory access command from the host or associated memory controller, 802. Specifically with reference to the output swing control described herein, the memory access commands of interest are any command that causes the memory device to generate an output bit or signal to provide to the host.

The memory device decodes and executes the command, 804. The memory device includes hardware control logic, which may also execute software control logic, which enables the device to decode the command and generate the signals necessary to access the data bit or bits to transmit to the host. Thus, the memory device generates a bit to output to the host, 806. The control logic can also configure the output driver hardware to transmit the output data. In one embodiment, the memory device transmits an output to the host based on an operating mode of the memory device. The host can control the operating mode of the memory device, for example, by command or by configuration setting. In one embodiment, the memory device control logic identifies an output voltage swing corresponding to the operating mode of the memory device, 808. The driver or driver subsystem can adjust the output voltage swing in accordance with the mode, or in accordance with the output swing desired for the transmission transaction, 810. The memory device driver can drive the signal line output with the adjusted or configured output voltage swing, 812.

FIG. 9 is a flow diagram of an embodiment of a process for controlling I/O swing of a memory device externally. In one embodiment, a memory controller associated with a memory device performs various operations to control the output voltage swing of the memory device. The control can directly configure or set the output voltage swing (e.g., such as by providing a source voltage), or by sending one or more signals to cause the memory device to internally generate programmable voltage levels to control the output voltage swing. The host can control the I/O swing in accordance with flow 900, and in accordance with any embodiment described herein. In one embodiment, the host identifies an I/O swing desired for the memory device, 902. The desired I/O swing can be in accordance with an I/O mode for the memory device. In one embodiment, reference to an output swing mode simply refers to the configuration that will cause the memory device to produce an output signal with the desired voltage swing characteristics.

In one embodiment, the host sets the mode for the memory device, 904. Setting the mode can include setting a register or generating a command to indicate the desired swing to the memory device. In one embodiment, setting the mode can include generating an output voltage to source to the memory device. In one embodiment, the output voltage is the same as used internally at the host for a driver coupled to the signal line(s) of the interface. In one embodiment, the output voltage is different than what is applied at the host driver. In one embodiment, the host sets the mode based on transmit conditions or other conditions known to the host. In one embodiment, the host generates and outputs a reduced voltage rail for the memory device driver, 906.

With the output swing characteristics set, the host can send a memory access command to the memory device, 908. The memory device will receive and execute the command and generate an output signal to be received at the host from the memory device. Thus, the host can receive bit(s) back from the memory device in accordance with the I/O swing configured for the memory device driver for the transaction. Different transactions (exchanges of I/O between the host and the memory device) can have different memory device driver mode settings or configurations. Thus, the output voltage swing can differ for different transactions.

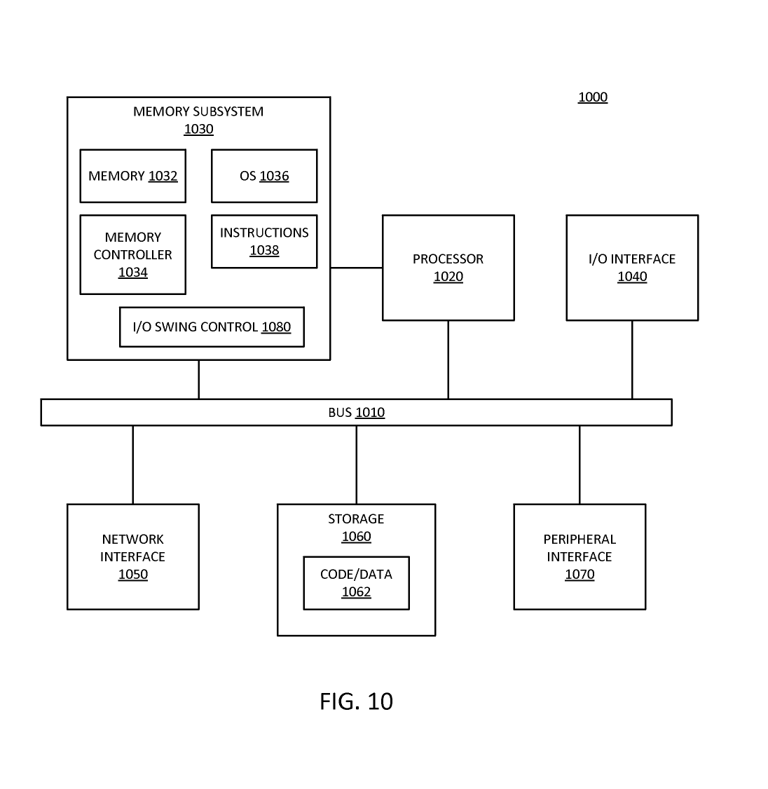

FIG. 10 is a block diagram of an embodiment of a computing system in which memory device I/O swing control can be implemented. System 1000 represents a computing device in accordance with any embodiment described herein, and can be a laptop computer, a desktop computer, a server, a gaming or entertainment control system, a scanner, copier, printer, routing or switching device, or other electronic device. System 1000 includes processor 1020, which provides processing, operation management, and execution of instructions for system 1000. Processor 1020 can include any type of microprocessor, central processing unit (CPU), processing core, or other processing hardware to provide processing for system 1000. Processor 1020 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 1030 represents the main memory of system 1000, and provides temporary storage for code to be executed by processor 1020, or data values to be used in executing a routine. Memory subsystem 1030 can include one or more memory devices such as read-only memory (ROM), flash memory, one or more varieties of random access memory (RAM), or other memory devices, or a combination of such devices. Memory subsystem 1030 stores and hosts, among other things, operating system (OS) 1036 to provide a software platform for execution of instructions in system 1000. Additionally, other instructions 1038 are stored and executed from memory subsystem 1030 to provide the logic and the processing of system 1000. OS 1036 and instructions 1038 are executed by processor 1020. Memory subsystem 1030 includes memory device 1032 where it stores data, instructions, programs, or other items. In one embodiment, memory subsystem includes memory controller 1034, which is a memory controller to generate and issue commands to memory device 1032. It will be understood that memory controller 1034 could be a physical part of processor 1020.

Processor 1020 and memory subsystem 1030 are coupled to bus/bus system 1010. Bus 1010 is an abstraction that represents any one or more separate physical buses, communication lines/interfaces, and/or point-to-point connections, connected by appropriate bridges, adapters, and/or controllers. Therefore, bus 1010 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 1010 can also correspond to interfaces in network interface 1050.

System 1000 also includes one or more input/output (I/O) interface(s) 1040, network interface 1050, one or more internal mass storage device(s) 1060, and peripheral interface 1070 coupled to bus 1010. I/O interface 1040 can include one or more interface components through which a user interacts with system 1000 (e.g., video, audio, and/or alphanumeric interfacing). Network interface 1050 provides system 1000 the ability to communicate with remote devices (e.g., servers, other computing devices) over one or more networks. Network interface 1050 can include an Ethernet adapter, wireless interconnection components, USB (universal serial bus), or other wired or wireless standards-based or proprietary interfaces.

Storage 1060 can be or include any conventional medium for storing large amounts of data in a nonvolatile manner, such as one or more magnetic, solid state, or optical based disks, or a combination. Storage 1060 holds code or instructions and data 1062 in a persistent state (i.e., the value is retained despite interruption of power to system 1000). Storage 1060 can be generically considered to be a “memory,” although memory 1030 is the executing or operating memory to provide instructions to processor 1020. Whereas storage 1060 is nonvolatile, memory 1030 can include volatile memory (i.e., the value or state of the data is indeterminate if power is interrupted to system 1000).

Peripheral interface 1070 can include any hardware interface not specifically mentioned above. Peripherals refer generally to devices that connect dependently to system 1000. A dependent connection is one where system 1000 provides the software and/or hardware platform on which operation executes, and with which a user interacts.

In one embodiment, memory subsystem 1030 includes memory devices 1032 with programmable output drivers. The programmable output driver enables memory device 1032 to generate outputs with different voltage swings, depending on the configuration of the output driver. In one embodiment, memory device 1032 generates the output voltage to use as the swing control. In one embodiment, memory controller 1034 sources the output voltage to memory device 1032 for use with the memory device driver. The control for the memory device output driver is represented by I/O swing control 1080. I/O swing control 1080 can include logic at memory device 1032. I/O swing control 1080 can include logic at memory controller 1034. I/O swing control 1080 can provide output swing control for the memory device driver in accordance with any embodiment described herein.

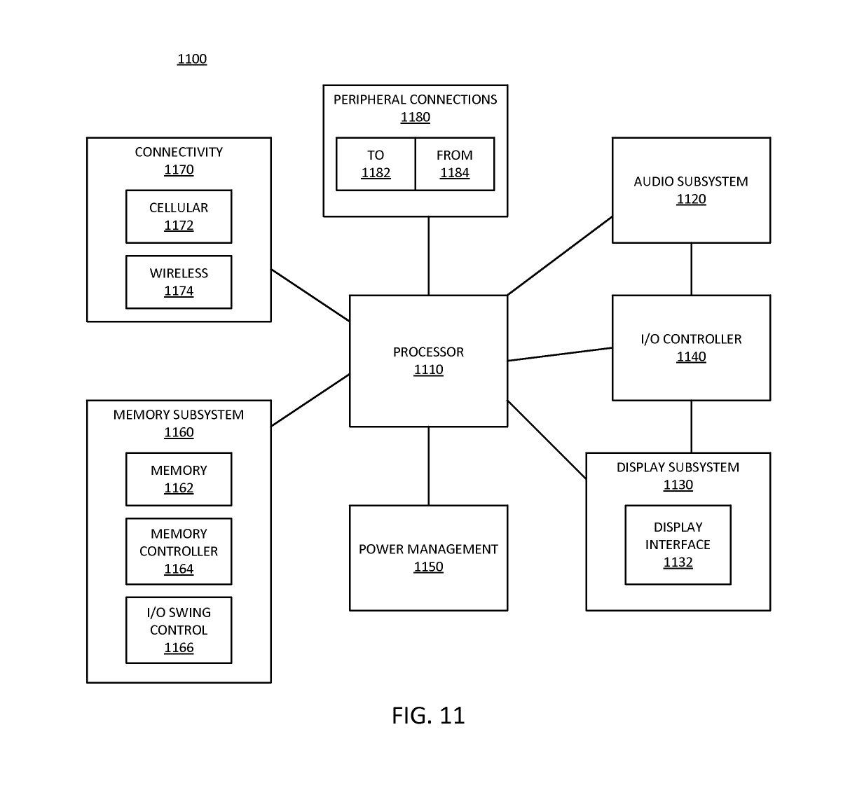

FIG. 11 is a block diagram of an embodiment of a mobile device in which memory device I/O swing control can be implemented. Device 1100 represents a mobile computing device, such as a computing tablet, a mobile phone or smartphone, a wireless-enabled e-reader, wearable computing device, or other mobile device. It will be understood that certain of the components are shown generally, and not all components of such a device are shown in device 1100.

Device 1100 includes processor 1110, which performs the primary processing operations of device 1100. Processor 1110 can include one or more physical devices, such as microprocessors, application processors, microcontrollers, programmable logic devices, or other processing means. The processing operations performed by processor 1110 include the execution of an operating platform or operating system on which applications and/or device functions are executed. The processing operations include operations related to I/O (input/output) with a human user or with other devices, operations related to power management, and/or operations related to connecting device 1100 to another device. The processing operations can also include operations related to audio I/O and/or display I/O.

In one embodiment, device 1100 includes audio subsystem 1120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 1100, or connected to device 1100. In one embodiment, a user interacts with device 1100 by providing audio commands that are received and processed by processor 1110.

Display subsystem 1130 represents hardware (e.g., display devices) and software (e.g., drivers) components that provide a visual and/or tactile display for a user to interact with the computing device. Display subsystem 1130 includes display interface 1132, which includes the particular screen or hardware device used to provide a display to a user. In one embodiment, display interface 1132 includes logic separate from processor 1110 to perform at least some processing related to the display. In one embodiment, display subsystem 1130 includes a touchscreen device that provides both output and input to a user. In one embodiment, display subsystem 1130 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra high definition or UHD), or others.

I/O controller 1140 represents hardware devices and software components related to interaction with a user. I/O controller 1140 can operate to manage hardware that is part of audio subsystem 1120 and/or display subsystem 1130. Additionally, I/O controller 1140 illustrates a connection point for additional devices that connect to device 1100 through which a user might interact with the system. For example, devices that can be attached to device 1100 might include microphone devices, speaker or stereo systems, video systems or other display device, keyboard or keypad devices, or other I/O devices for use with specific applications such as card readers or other devices.

As mentioned above, I/O controller 1140 can interact with audio subsystem 1120 and/or display subsystem 1130. For example, input through a microphone or other audio device can provide input or commands for one or more applications or functions of device 1100. Additionally, audio output can be provided instead of or in addition to display output. In another example, if display subsystem includes a touchscreen, the display device also acts as an input device, which can be at least partially managed by I/O controller 1140. There can also be additional buttons or switches on device 1100 to provide I/O functions managed by I/O controller 1140.

In one embodiment, I/O controller 1140 manages devices such as accelerometers, cameras, light sensors or other environmental sensors, gyroscopes, global positioning system (GPS), or other hardware that can be included in device 1100. The input can be part of direct user interaction, as well as providing environmental input to the system to influence its operations (such as filtering for noise, adjusting displays for brightness detection, applying a flash for a camera, or other features). In one embodiment, device 1100 includes power management 1150 that manages battery power usage, charging of the battery, and features related to power saving operation.

Memory subsystem 1160 includes memory device(s) 1162 for storing information in device 1100. Memory subsystem 1160 can include nonvolatile (state does not change if power to the memory device is interrupted) and/or volatile (state is indeterminate if power to the memory device is interrupted) memory devices. Memory 1160 can store application data, user data, music, photos, documents, or other data, as well as system data (whether long-term or temporary) related to the execution of the applications and functions of system 1100. In one embodiment, memory subsystem 1160 includes memory controller 1164 (which could also be considered part of the control of system 1100, and could potentially be considered part of processor 1110). Memory controller 1164 includes a scheduler to generate and issue commands to memory device 1162.

Connectivity 1170 includes hardware devices (e.g., wireless and/or wired connectors and communication hardware) and software components (e.g., drivers, protocol stacks) to enable device 1100 to communicate with external devices. The external device could be separate devices, such as other computing devices, wireless access points or base stations, as well as peripherals such as headsets, printers, or other devices.

Connectivity 1170 can include multiple different types of connectivity. To generalize, device 1100 is illustrated with cellular connectivity 1172 and wireless connectivity 1174. Cellular connectivity 1172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 1174 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 1180 include hardware interfaces and connectors, as well as software components (e.g., drivers, protocol stacks) to make peripheral connections. It will be understood that device 1100 could both be a peripheral device (“to” 1182) to other computing devices, as well as have peripheral devices (“from” 1184) connected to it. Device 1100 commonly has a “docking” connector to connect to other computing devices for purposes such as managing (e.g., downloading and/or uploading, changing, synchronizing) content on device 1100. Additionally, a docking connector can allow device 1100 to connect to certain peripherals that allow device 1100 to control content output, for example, to audiovisual or other systems.

In addition to a proprietary docking connector or other proprietary connection hardware, device 1100 can make peripheral connections 1180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, memory subsystem 1160 includes memory devices 1162 with programmable output drivers. The programmable output driver enables memory device 1162 to generate outputs with different voltage swings, depending on the configuration of the output driver. In one embodiment, memory device 1162 generates the output voltage to use as the swing control. In one embodiment, memory controller 1164 sources the output voltage to memory device 1162 for use with the memory device driver. The control for the memory device output driver is represented by I/O swing control 1166. I/O swing control 1166 can include logic at memory device 1162. I/O swing control 1166 can include logic at memory controller 1164. I/O swing control 1166 can provide output swing control for the memory device driver in accordance with any embodiment described herein.

In one aspect, a memory device for interfacing with a host system includes an input/output (I/O) signal line interface for an I/O signal line coupled between the memory device and an associated memory controller; and a programmable driver to dynamically adjust an output voltage swing for transmission via the I/O signal line interface from the memory device to the memory controller over the I/O signal line, the adjusted output voltage swing independent of resistance of the programmable driver.

In one embodiment, the I/O signal line interface is further to terminate the I/O signal line to a high voltage rail. In one embodiment, the I/O signal line interface is further to terminate the I/O signal line to a low voltage rail. In one embodiment, the I/O signal line interface is further to terminate the I/O signal line to a mid-rail voltage. In one embodiment, the I/O signal line interface comprises one of multiple I/O signal line interfaces for multiple different I/O signal lines, and further comprising a programmable driver for each I/O signal line interface, wherein each programmable driver is to separately adjust an output voltage swing for transmission via the separate I/O signal line interfaces. In one embodiment, the programmable driver is further to generate an internal variable voltage swing. In one embodiment, the programmable driver is further to receive a variable voltage rail from the memory controller. In one embodiment, the variable voltage rail received from the memory controller comprises a same voltage rail applied to a driver of the memory controller. In one embodiment, the variable voltage rail received from the memory controller comprises a different voltage rail than a voltage rail applied to a driver of the memory controller. In one embodiment, the programmable driver is to dynamically adjust the output voltage swing to control swing at a granularity of one bit. In one embodiment, the programmable driver is to dynamically adjust the output voltage swing to control swing at a granularity of one byte. In one embodiment, the programmable driver is to dynamically adjust the output voltage swing to control swing at a granularity of one device. In one embodiment, the programmable driver is to dynamically adjust the output voltage swing to control swing at a granularity of one bus. In one embodiment, the programmable driver is to dynamically adjust the output voltage swing to control swing at a granularity of one channel. In one embodiment, the programmable driver has an n-type-n-type driver architecture. In one embodiment, the programmable driver has an n-type-n-type driver architecture. In one embodiment, the programmable driver has a p-type-p-type driver architecture. In one embodiment, the programmable driver has a p-type-n-type driver architecture. In one embodiment, the programmable driver is to dynamically adjust the output voltage swing based on an operating mode of the memory device, wherein the operating mode is set by a mode register of the memory device. In one embodiment, the programmable driver is to dynamically adjust the output voltage swing based on an operating mode of the memory device, wherein the operating mode is set by a command received by the memory device from the memory controller. In one embodiment, the programmable driver is to dynamically adjust the output voltage swing based on a frequency used for I/O by the memory device. In one embodiment, the programmable driver is to further dynamically adjust one or more voltage regulator characteristics. In one embodiment, the one or more voltage regulator characteristics includes regulator bandwidth. In one embodiment, the one or more voltage regulator characteristics includes regulator efficiency. In one embodiment, the one or more voltage regulator characteristics includes non-linear control. In one embodiment, the one or more voltage regulator characteristics includes low-load power management. In one embodiment, the driver is a voltage mode driver.

In one aspect, an electronic device with a memory subsystem includes a memory device including an input/output (I/O) signal line interface for an I/O signal line coupled between the memory device and an associated memory controller; and a programmable driver to dynamically adjust an output voltage swing for transmission via the I/O signal line interface from the memory device to the memory controller over the I/O signal line, the adjusted output voltage swing independent of resistance of the programmable driver; and a touchscreen display coupled to generate a display based on data accessed from the memory device. Any embodiment described with respect to the memory device for interfacing with a host system can also apply to the electronic device.

In one aspect a method for interfacing in a memory subsystem includes generating a bit to output via an input/output (I/O) signal line interface for an I/O signal line coupled between a memory device and an associated memory controller; dynamically adjusting an output voltage swing for transmission of the bit via the I/O signal line interface based on a source voltage; and driving the I/O signal line interface with the dynamically adjusted output voltage swing.

In one embodiment, the I/O signal line interface is terminated to one of a high voltage rail, a low voltage rail, or a mid-rail voltage. In one embodiment, dynamically adjusting the output voltage swing comprises adjusting the output voltage swing to a different output voltage swing than a voltage swing of a different I/O signal line interface of the memory device. In one embodiment, dynamically adjusting the output voltage swing based on the source voltage comprises internally regulating a source voltage to a reduced voltage swing. In one embodiment, dynamically adjusting the output voltage swing based on the source voltage comprises receiving a variable voltage rail from the memory controller. In one embodiment, dynamically adjusting the output voltage swing based on the source voltage further comprises receiving a reduced voltage swing source voltage that is a same voltage source signal applied to a driver of the signal line of the memory controller. In one embodiment, dynamically adjusting the output voltage swing based on the source voltage further comprises receiving a reduced voltage swing source voltage that is a different voltage source signal than one applied to a driver of the signal line of the memory controller. In one embodiment, dynamically adjusting the output voltage swing comprises dynamically adjusting the output voltage swing to control output swing for a granularity of control of one of bit, byte, device, bus, or channel. In one embodiment, the programmable driver has a driver architecture selected from one of an n-type-n-type driver, n-type-p-type driver, p-type-p-type driver, or p-type-n-type driver. In one embodiment, dynamically adjusting the output voltage swing comprises dynamically adjusting the output voltage swing based on an operating mode of the memory device, wherein the operating mode is set by a mode register of the memory device. In one embodiment, dynamically adjusting the output voltage swing comprises dynamically adjusting the output voltage swing based on an operating mode of the memory device, wherein the operating mode is set by a command received by the memory device from the memory controller. In one embodiment, dynamically adjusting the output voltage swing comprises dynamically adjusting the output voltage swing based on a frequency used for I/O by the memory device. In one embodiment, dynamically adjusting the output voltage swing further comprises dynamically adjusting one or more voltage regulator characteristics, including regulator bandwidth, regulator efficiency, non-linear control, or low-load power management.

In one aspect an article of manufacture comprises a computer readable storage medium having content stored thereon, which when executed by a machine performs operations to execute a method for interfacing in a memory subsystem, including generating a bit to output via an input/output (I/O) signal line interface for an I/O signal line coupled between a memory device and an associated memory controller; dynamically adjusting an output voltage swing for transmission of the bit via the I/O signal line interface based on a source voltage; and driving the I/O signal line interface with the dynamically adjusted output voltage swing. Any embodiment described with respect to the method for interfacing with a host system can also apply to the article of manufacture.

In one aspect, an apparatus for interfacing in a memory subsystem includes means for generating a bit to output via an input/output (I/O) signal line interface for an I/O signal line coupled between a memory device and an associated memory controller; means for dynamically adjusting an output voltage swing for transmission of the bit via the I/O signal line interface based on a source voltage; and means for driving the I/O signal line interface with the dynamically adjusted output voltage swing. Any embodiment described with respect to the method for interfacing with a host system can also apply to the apparatus.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory device for interfacing with a host system, comprising:
an input/output (I/O) signal line interface for an I/O signal line coupled between the memory device and an associated memory controller; and
a programmable driver to dynamically adjust an output voltage swing for transmission via the I/O signal line interface from the memory device to the memory controller over the I/O signal line, the adjusted output voltage swing independent of resistance of the programmable driver.

2. The memory device of claim 1, wherein the I/O signal line interface is further to terminate the I/O signal line to one of a high voltage rail, a low voltage rail, or a mid-rail voltage.

3. The memory device of claim 1, wherein the I/O signal line interface comprises one of multiple I/O signal line interfaces for multiple different I/O signal lines, and further comprising a programmable driver for each I/O signal line interface, wherein each programmable driver is to separately adjust an output voltage swing for transmission via the separate I/O signal line interfaces.

4. The memory device of claim 1, wherein the programmable driver is further to generate an internal variable voltage swing.

5. The memory device of claim 1, wherein the programmable driver is further to receive a variable voltage rail from the memory controller.

6. The memory device of claim 5, wherein the variable voltage rail received from the memory controller comprises a same voltage rail applied to a driver of the memory controller.

7. The memory device of claim 5, wherein the variable voltage rail received from the memory controller comprises a different voltage rail than a voltage rail applied to a driver of the memory controller.

8. The memory device of claim 1, wherein the programmable driver is to dynamically adjust the output voltage swing to control swing at a granularity of one of a bit, byte, device, bus, or channel.

9. The memory device of claim 1, wherein the programmable driver has a driver architecture selected from one of an n-type-n-type driver, n-type-p-type driver, p-type-p-type driver, or p-type-n-type driver.

10. The memory device of claim 1, wherein the programmable driver is to dynamically adjust the output voltage swing based on an operating mode of the memory device, wherein the operating mode is set by a mode register of the memory device.

11. The memory device of claim 1, wherein the programmable driver is to dynamically adjust the output voltage swing based on an operating mode of the memory device, wherein the operating mode is set by a command received by the memory device from the memory controller.

12. The memory device of claim 1, wherein the programmable driver is to dynamically adjust the output voltage swing based on a frequency used for I/O by the memory device.

13. The memory device of claim 1, wherein the programmable driver is to further dynamically adjust one or more voltage regulator characteristics, including regulator bandwidth, regulator efficiency, non-linear control, or low-load power management.

14. A method for interfacing in a memory subsystem, comprising:
generating a bit to output via an input/output (I/O) signal line interface for an I/O signal line coupled between a memory device and an associated memory controller;
dynamically adjusting an output voltage swing for transmission of the bit via the I/O signal line interface based on a source voltage; and
driving the I/O signal line interface with the dynamically adjusted output voltage swing.

15. The method of claim 14, wherein dynamically adjusting the output voltage swing comprises adjusting the output voltage swing to a different output voltage swing than a voltage swing of a different I/O signal line interface of the memory device.

16. The method of claim 14, wherein dynamically adjusting the output voltage swing based on the source voltage comprises internally regulating a source voltage to a reduced voltage swing.

17. The method of claim 14, wherein dynamically adjusting the output voltage swing based on the source voltage further comprises receiving a reduced voltage swing source voltage that is a same voltage source signal applied to a driver of the signal line of the memory controller.

18. The method of claim 14, wherein dynamically adjusting the output voltage swing based on the source voltage further comprises receiving a reduced voltage swing source voltage that is a different voltage source signal than one applied to a driver of the signal line of the memory controller.

19. The method of claim 14, wherein dynamically adjusting the output voltage swing comprises dynamically adjusting the output voltage swing to control output swing for a granularity of control of one of bit, byte, device, bus, or channel.

20. An electronic device with a memory subsystem, comprising:
a memory device including
an input/output (I/O) signal line interface for an I/O signal line coupled between the memory device and an associated memory controller; and
a programmable driver to dynamically adjust an output voltage swing for transmission via the I/O signal line interface from the memory device to the memory controller over the I/O signal line, the adjusted output voltage swing independent of resistance of the programmable driver; and
a touchscreen display coupled to generate a display based on data accessed from the memory device.

21. The electronic device of claim 20, wherein the I/O signal line interface comprises one of multiple I/O signal line interfaces for multiple different I/O signal lines, and wherein the programmable driver is one of multiple programmable drivers, one for each I/O signal line interface, wherein each programmable driver is to separately adjust an output voltage swing for transmission via the separate I/O signal line interfaces.

22. The electronic device of claim 20, wherein the programmable driver is further to generate an internal variable voltage swing.

23. The electronic device of claim 20, wherein the programmable driver is to dynamically adjust the output voltage swing for a granularity of control of one of a bit, byte, device, bus, or channel.
